(19) United States
(12) Patent Application Publication
(10) Pub. No.: US 2018/0160194 A1
(43) Pub. Date: Jun. 7, 2018

(54) METHODS, SYSTEMS, AND MEDIA FOR ENHANCING TWO-DIMENSIONAL VIDEO CONTENT ITEMS WITH SPHERICAL VIDEO CONTENT

(71) Applicant: Google Inc., Mountain View, CA (US)

(72) Inventors: Leon Bayliss, Los Angeles, CA (US); Richard Hale, London (GB)

(21) Appl. No.: 15/366,432

(22) Filed: Dec. 1, 2016

(51) Int. Cl. H04N 21/6543; H04N 21/81; H04N 21/44; H04N 21/435

(52) U.S. Cl. CPC H04N 21/6543; H04N 21/816; H04N 21/8146; H04N 21/435; H04N 21/44016

(57) ABSTRACT

Methods, systems, and media for enhancing two-dimensional video content items with spherical video content are provided. In some embodiments, the method comprises: receiving an indication of a two-dimensional video content item to be presented on a user device; determining image information associated with one or more image frames of the two-dimensional video content item; identifying spherical video content based on the image information associated with the one or more image frames of the two-dimensional video content item, wherein the spherical video content is related to the determined image information and wherein the spherical video content includes a plurality of views; identifying a position corresponding to a first view of the plurality of views within the related spherical video content at which to insert the two-dimensional video content item; and generating a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

### TECHNICAL FIELD

The disclosed subject matter relates to methods, systems, and media for enhancing two-dimensional video content items with spherical video content.

### BACKGROUND

People frequently watch video content, such as television programs, movies, and videos, and the content may be more enjoyable to view when presented in an immersive, three-dimensional context. It can, however, be difficult for the content creators of the video content to produce and distribute such immersive content. For example, these content creators may convert the video content by simply placing it in a 360-degree environment. This conversion does not tend to enhance the experience of the viewer. For example, the converted video content is not any more immersive than the original video content.

Accordingly, it is desirable to provide methods, systems, and media for enhancing two-dimensional video content items with spherical video content.

### SUMMARY

Methods, systems, and media for enhancing two-dimensional video content items with spherical video content are provided.

In accordance with some embodiments of the disclosed subject matter, a method for enhancing video content items is provided, the method comprising: receiving an indication of a two-dimensional video content item to be presented on a user device; determining image information associated with one or more image frames of the two-dimensional video content item; identifying spherical video content based on the image information associated with the one or more image frames of the two-dimensional video content item, wherein the spherical video content is related to the determined image information and wherein the spherical video content includes a plurality of views; identifying a position corresponding to a first view of the plurality of views within the related spherical video content at which to insert the two-dimensional video content item; and generating a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

In some embodiments, the related spherical video content is related to an environment depicted in the one or more image frames of the two-dimensional video content item.

In some embodiments, inserting the two-dimensional video content item within the related spherical video content at the identified position corresponding to the first view for presentation on the user device further comprises transmitting instructions to the user device that include one or more coordinates at which the two-dimensional video item is to be positioned relative to the spherical video content.

In some embodiments, identifying the spherical video content further comprises determining an identifier corresponding to the spherical video content that is stored in association with an identifier of the two-dimensional video content item.

In some embodiments, an identity of the spherical video content item is specified by a content creator of the two-dimensional video content item.

In some embodiments, identifying the spherical video content further comprises: identifying a plurality of candidate spherical video content based on first metadata associated with the two-dimensional video content item and second metadata associated with the two-dimensional video content item; and selecting at least one candidate spherical video content item from the plurality of candidate spherical video content.

In some embodiments, the method further comprises causing the two-dimensional video content item to be inserted within second spherical video content during presentation of a second portion of the two-dimensional video content item, wherein the second spherical video content is related to the one or more image frames associated with the second portion of the two-dimensional video content item and wherein the two-dimensional video content item is inserted within the related spherical video content during presentation of a first portion of the two-dimensional video content item.

In some embodiments, the method further comprises modifying at least one visual characteristic of the related spherical video content based on visual characteristics of the two-dimensional video content item.

In some embodiments, the method further comprises: identifying one or more portions of the two-dimensional video content item that are unrelated to the spherical video content; and inhibiting presentation of the spherical video content during presentations of the one or more portions of the two-dimensional video content item that are unrelated to the spherical video content.

In some embodiments, presentation of the spherical video content item is performed in a full-screen mode.

In some embodiments, the method further comprises causing a notification related to the two-dimensional video content item to be presented on the user device in response to determining that presentation of the spherical video content item on the user device has been completed.

In accordance with some embodiments of the disclosed subject matter, a system for enhancing video content items is provided, the system comprising: receive an indication of a two-dimensional video content item to be presented on a user device; determine image information associated with one or more image frames of the two-dimensional video content item; identify spherical video content based on the image information associated with the one or more image frames of the two-dimensional video content item, wherein the spherical video content is related to the determined image information and wherein the spherical video content includes a plurality of views; identify a position corresponding to a first view of the plurality of views within the related spherical video content at which to insert the two-dimensional video content item; and generate a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

In accordance with some embodiments of the disclosed subject matter, a non-transitory computer-readable medium containing computer-executable instructions that, when executed by a processor, cause the processor to perform a method for enhancing two-dimensional video content items is provided, the method comprising: receiving an indication of a two-dimensional video content item to be presented on a user device; determining image information associated with one or more image frames of the two-dimensional video content item; identifying spherical video content based on the image information associated with the one or more image frames of the two-dimensional video content item, wherein the spherical video content is related to the determined image information and wherein the spherical video content includes a plurality of views; identifying a position corresponding to a first view of the plurality of views within the related spherical video content at which to insert the two-dimensional video content item; and generating a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

In accordance with some embodiments of the disclosed subject matter, a system for enhancing two-dimensional video content items is provided, the system comprising: means for receiving an indication of a two-dimensional video content item to be presented on a user device; means for determining image information associated with one or more image frames of the two-dimensional video content item; means for identifying spherical video content based on the image information associated with the one or more image frames of the two-dimensional video content item, wherein the spherical video content is related to the determined image information and wherein the spherical video content includes a plurality of views; means for identifying a position corresponding to a first view of the plurality of views within the related spherical video content at which to insert the two-dimensional video content item; and means for generating a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show examples of user interfaces that present two-dimensional video content that is inserted into or otherwise incorporated into spherical video content, where the spherical video content provides an immersive background image that is related to the two-dimensional video content, in accordance with some embodiments of the disclosed subject matter.

FIG. 2 shows a schematic diagram of an illustrative system suitable for implementation of mechanisms described herein for enhancing two-dimensional video content items with spherical video content in accordance with some embodiments of the disclosed subject matter.

FIG. 3 shows a detailed example of hardware that can be used in a server and/or a user device of FIG. 2 in accordance with some embodiments of the disclosed subject matter.

FIG. 4 shows an example of a process for generating and transmitting instructions for presenting two-dimensional video content that is inserted into or otherwise incorporated into spherical video content in accordance with some embodiments of the disclosed subject matter.

FIG. 5 shows an example of a process for presenting a two-dimensional video content that is inserted into or otherwise incorporated into spherical video content on a user device in accordance with some embodiments of the disclosed subject matter.

FIGS. 6A, 6B, and 6C show examples of user interfaces for presenting a video content item that is inserted into or otherwise incorporated into spherical video content in response to selection of an advertisement associated with the video content item and presenting a notification related to the video content item after presentation of the video content item is finished.

### DETAILED DESCRIPTION

In accordance with various embodiments, mechanisms (which can include methods, systems, and media) for enhancing two-dimensional video content items with spherical video content are provided.

In some embodiments, the mechanisms described herein can cause a two-dimensional video content item to be inserted into or otherwise incorporated into related spherical video content (and/or other suitable three-dimensional video content) and presented on a user device, thereby creating an immersive, three-dimensional viewing experience of the original two-dimensional video content item. For example, the spherical video content can include background image frames that provide a 360-degree three-dimensional view of a background scene that is related to the two-dimensional video content. In a more particular example, in some embodiments, the spherical video content can depict an environment (e.g., a geographic location, a background scene, a type of building, and/or any other suitable type of location) in which at least a portion of the two-dimensional video content takes place.

In some embodiments, an indication can be received to generate spherical video content that is related to at least a portion of a two-dimensional video content item. It should be noted that, in some embodiments, the spherical video content can be generated using any suitable number of camera devices. It should also be noted that, in some embodiments, the spherical video content can be generated using any suitable type of camera devices. For example, in some embodiments, multiplexed views in various directions can be recorded at the same time by one or more video capture devices, and the resulting video content can be stitched together to allow a user to change a viewpoint of the presented spherical video content, for example, by clicking and/or dragging the spherical video content with a user input device or by interpreting a head movement as a directional input when using a head-mountable device.

In some embodiments, the mechanisms described herein can identify the spherical video content that relates to the two-dimensional video content item. In turn, the mechanisms can transmit instructions to the user device to insert the two-dimensional video content item into the spherical video content. For example, in some embodiments, the instructions can indicate one or more file locations for accessing the related spherical video content and the two-dimensional video content item. In a more particular example, the instructions can include file locations for obtaining the files needed for the user device to generate a spherical video content item corresponding to the original two-dimensional video content item. As another example, in some embodiments, the instructions can indicate a position within the spherical video content at which to insert the two-dimensional video content item. This can include, for example, a designated position that superimposes the two-dimensional video content item onto the related spherical video content. In a more particular example, the three-dimensional spherical video content can be generated to include a window for inserting the two-dimensional video content item of particular dimensions at a particular location. As yet another example, in some embodiments, the instructions can include rendering instructions that indicate a border around the two-dimensional video content item, shadowing effects, lighting effects, a visual perspective, and/or any other suitable display effects for presenting the two-dimensional video content item in connection with the spherical video content.

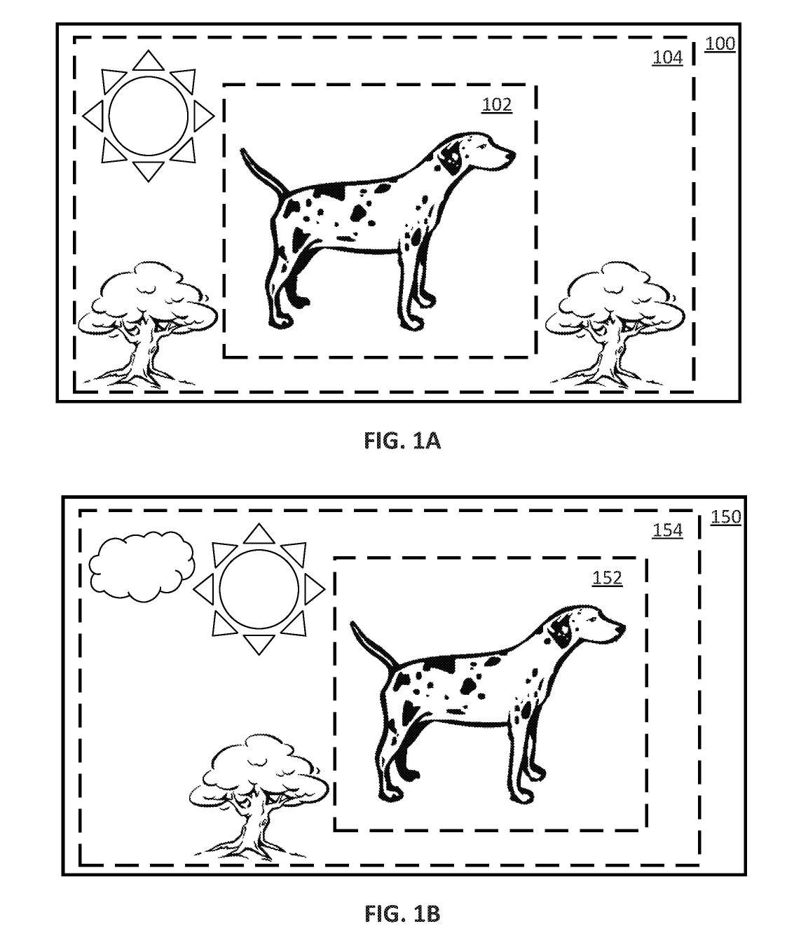

Turning to FIGS. 1A and 1B, examples 100 and 150 of user interfaces that present two-dimensional video content that is inserted into or otherwise incorporated into spherical video content, where the spherical video content provides an immersive background image that is related to the two-dimensional video content, are shown in accordance with some embodiments of the disclosed subject matter.

As illustrated, in some embodiments, user interface 100 can include a presentation of video content 102. In some embodiments, video content 102 can be any suitable video content, such as a video, a video from a collection of videos (e.g., from a playlist of videos, and/or any other suitable collection of videos), a television program, live-streamed video content, a movie, and/or any other suitable type of video content. In some embodiments, video content 102 can be presented within a video player window, which can include one or more video player controls (e.g., a pause playback control, a volume adjustment, and/or any other suitable controls). In some embodiments, the video player window can be omitted and/or hidden.

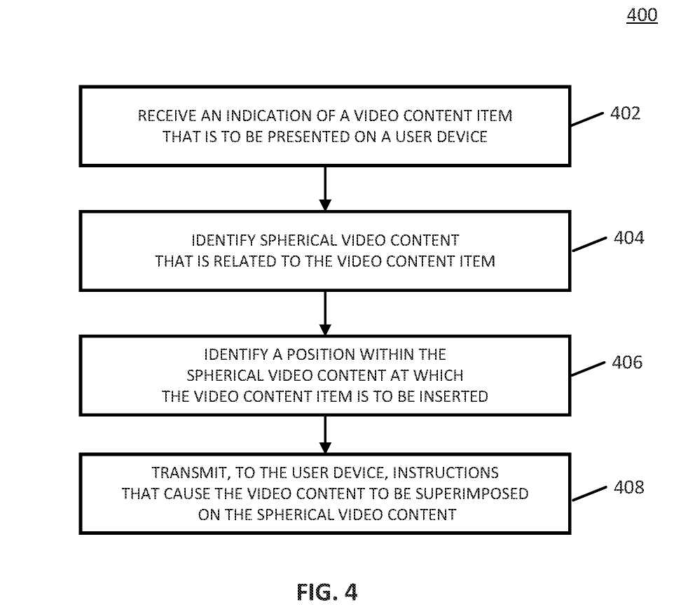

In some embodiments, video content 102 can be inserted into or otherwise incorporated into a presentation of spherical video content 104, as shown in FIG. 1A. In some embodiments, spherical video content 104 can be any suitable content, such as a still image, video content, animations, graphics, a photo, a slideshow, interactive content containing one or more interactive elements, and/or any other suitable type of content. Additionally, in some embodiments, spherical video content 104 can be related to video content 102 in any suitable manner. For example, in some embodiments, a topic of video content 102 can be related to a topic of spherical video content 104. As a more particular example, in instances where the video content belongs to a particular genre (e.g., a horror film, a comedy, and/or any other suitable genre), spherical video content 104 can include photos and/or videos of buildings and/or locations that are frequently used in content of the genre. As a specific example, if the video content is a horror film, spherical video content 104 can be photos and/or videos of an old house, a cemetery, and/or any other suitable locations. As another example, in some embodiments, a geographic location associated with spherical video content 104 can correspond to a geographic location associated with video content 102. As a more particular example, in instances where the video content item is a travel video (e.g., related to a particular geographic location), spherical video content 104 can include photographs and/or videos that depict the particular geographic location (e.g., from live-feed cameras at the geographic location, pre-recorded footage from one or more cameras located at the geographic location, and/or any other suitable content). Further details for identifying spherical video content 104 are described below in connection with FIG. 4.

In some embodiments, spherical video content 104 can include a designated area for the insertion of video content 102. For example, spherical video content 104 can be resized and/or positioned at particular coordinates within spherical video content 104. In a more particular example, video content 102 can be a video relating to camping that is positioned to be played back within a designated window area in spherical video content 104, which depicts a detailed campground scene. Additionally or alternatively, video content 102 can be overlaid or superimposed onto spherical video content at any suitable position (e.g., at a randomly selected position within spherical video content 104, at particular coordinates within spherical video content 104, at a particular size within spherical video content 104). For example, video content 102 can be a video relating to camping that is placed at any suitable location within spherical video content 104 that depicts a forest scene.

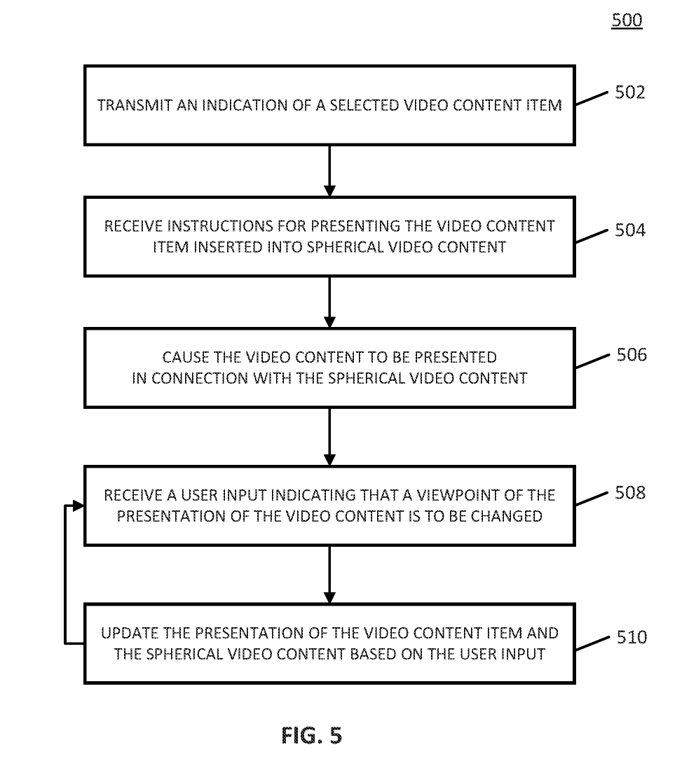

In some embodiments, a user can manipulate a viewpoint of spherical video content 104, as described below in connection with FIG. 5. For example, in some embodiments, the user can click and drag spherical video content 104 (or provide any other suitable directional input), causing the portion of spherical video content 104 that is presented to be changed, as shown in FIG. 1B. For example, in instances where a user has dragged spherical video content 104 and/or user interface 100 to the right in FIG. 1A, user interface 150 which includes spherical video content 154 presented with a different viewpoint relative to spherical video content 104 can be presented. Additionally, in some embodiments, a position, size, and/or perspective of video content 102 can be changed. For example, as shown in FIG. 1B, if the viewpoint is changed to drag spherical video content 104 to the right, video content 152 can be video content 102 presented in a position to the right of the position of video content 102. Additionally or alternatively, a size and/or a perspective of video content 152 can be changed, for example, by making a viewpoint of video content 152 be above or below video content 152, by scaling and/or warping video content 152, and/or with any other suitable manipulation(s).

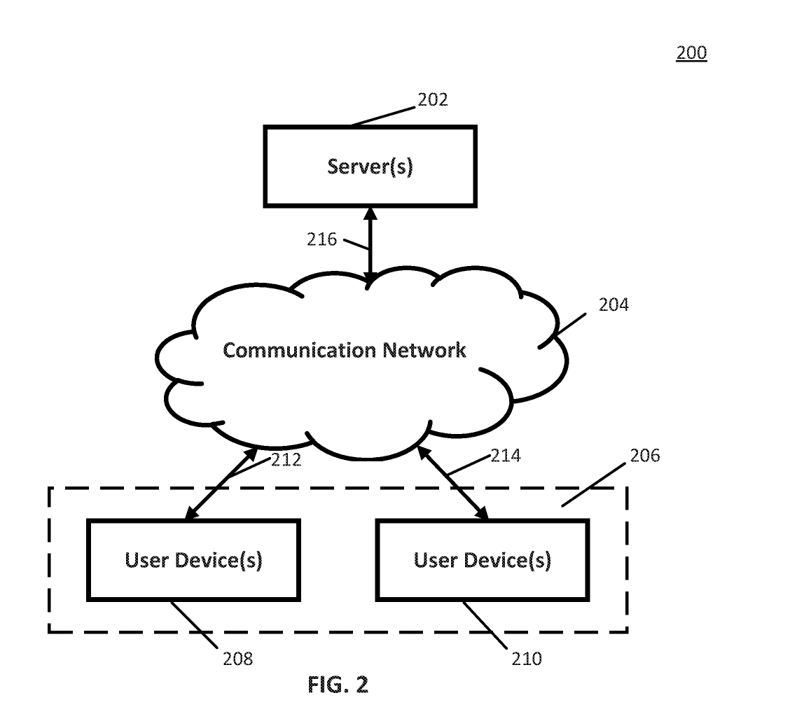

Turning to FIG. 2, an example of an illustrative system 200 suitable for implementation of mechanisms described herein for enhancing two-dimensional video content items with spherical video content in accordance with some embodiments of the disclosed subject matter is shown. As illustrated, hardware 200 can include one or more servers, such as a data server 202, a communication network 204, and/or one or more user devices 206, such as user devices 208 and 210.

In some embodiments, server(s) 202 can be any suitable server(s) for storing video content, storing spherical video content and/or images, generating instructions for presenting video content in connection with spherical video content, transmitting instructions to a user device to present video content in connection with spherical video content, and/or performing any other suitable functions. For example, in some embodiments, server(s) 202 can receive a request to present a particular video content item on a user device and can identify related spherical video content (e.g., related video content, related images, and/or any other suitable content). In some embodiments, server(s) 202 can then transmit instructions to the user device that cause the user device to present the video content overlaid on, superimposed on, or otherwise incorporated into the spherical video content, as described below in connection with FIG. 4. Alternatively, in some embodiments, server(s) 202 can insert the two-dimensional video content into the related spherical video content to generate a spherical video content file, which is transmitted to the user device. In some embodiments, server(s) 202 can be omitted.

Communication network 204 can be any suitable combination of one or more wired and/or wireless networks in some embodiments. For example, communication network 206 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 206 can be connected by one or more communications links 212 to communication network 204 that can be linked via one or more communications links (e.g., communications link 214) to server(s) 202. Communications links 212 and/or 214 can be any communications links suitable for communicating data among user devices 206 and server(s) 202 such as network links, dial-up links, wireless links, hard-wired links, any other suitable communications links, or any suitable combination of such links.

In some embodiments, user devices 206 can include one or more computing devices suitable for requesting video content, viewing video content, changing a view of video content, and/or any other suitable functions. For example, in some embodiments, user devices 206 can be implemented as a mobile device, such as a smartphone, mobile phone, a tablet computer, a laptop computer, a vehicle (e.g., a car, a boat, an airplane, or any other suitable vehicle) entertainment system, a portable media player, and/or any other suitable mobile device. As another example, in some embodiments, user devices 206 can be implemented as a non-mobile device such as a desktop computer, a set-top box, a television, a streaming media player, a game console, and/or any other suitable non-mobile device.

Although server 202 is illustrated as a single device, the functions performed by server 202 can be performed using any suitable number of devices in some embodiments. For example, in some embodiments, the functions performed by server 202 can be performed on a single server. As another example, in some embodiments, multiple devices can be used to implement the functions performed by server 202.

Although two user devices 208 and 210 are shown in FIG. 2, any suitable number of user devices, and/or any suitable types of user devices, can be used in some embodiments.

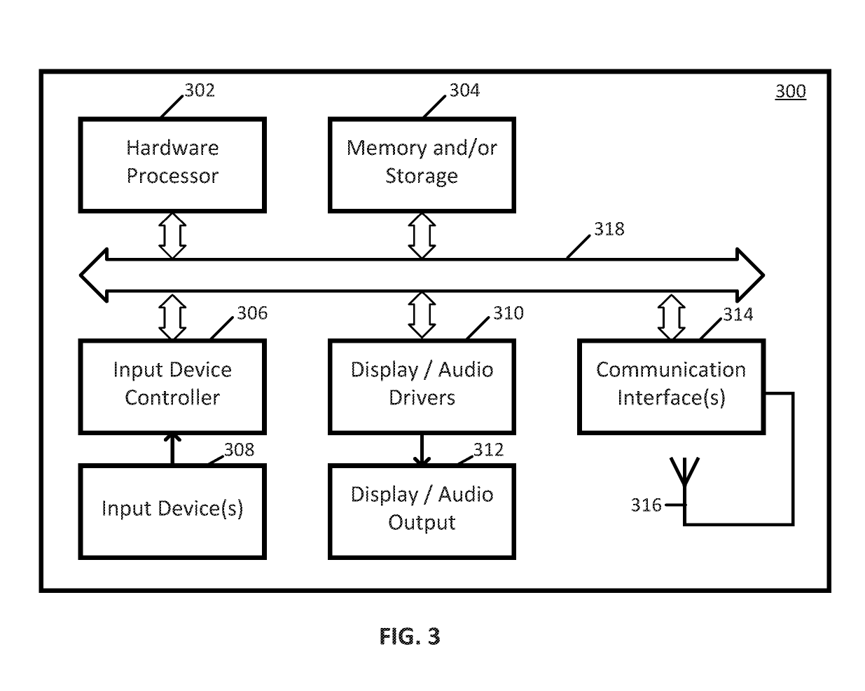

Server(s) 202 and user devices 206 can be implemented using any suitable hardware in some embodiments. For example, in some embodiments, devices 202 and 206 can be implemented using any suitable general purpose computer or special purpose computer. For example, a server may be implemented using a special purpose computer. Any such general purpose computer or special purpose computer can include any suitable hardware. For example, as illustrated in example hardware 300 of FIG. 3, such hardware can include hardware processor 302, memory and/or storage 304, an input device controller 306, an input device 308, display/audio drivers 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 302 can be controlled by a server program stored in memory and/or storage 304 of a server (e.g., such as server 202). For example, the server program can cause hardware processor 302 to transmit video content to user device 206, transmit instructions to render the video content overlaid on, superimposed on, or otherwise incorporated into spherical video content, and/or perform any other suitable actions. In another example, the server program can cause hardware processor 302 to analyze a two-dimensional video content item to determine information relating to the scenes depicted in the video content item, determine spherical video content that is related to the scenes depicted in the video content item, and/or insert at least a portion of the image frames from a two-dimensional video content item into the spherical video content to generate a spherical video content item. In yet another example, the server program can cause hardware processor 302 to transmit a request to a different device for analyzing the two-dimensional video content item to determine information relating to the scenes depicted in the video content item and, in response to receiving the information relating to the scenes depicted in the video content item, conduct a search through a database of spherical video content for related spherical video content corresponding to the information relating to the scenes depicted in the video content item. In continuing this example, in response to determining that there are no matches in the database of spherical video content or that a related spherical video content is not selected for use, the server program can cause hardware processor 302 to transmit an indicator that related spherical video content for the two-dimensional video content item is to be generated. In some embodiments, hardware processor 302 can be controlled by a computer program stored in memory and/or storage 304 of user device 206. For example, the computer program can cause hardware processor 302 to present video content, change a view of the video content, and/or perform any other suitable actions.

Memory and/or storage 304 can be any suitable memory and/or storage for storing programs, data, media content, advertisements, and/or any other suitable information in some embodiments. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some embodiments. For example, input device controller 306 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or any other type of input device. In another example, input device controller 306 can be circuitry for receiving input from a head-mountable device (e.g., for presenting virtual reality content or augmented reality content).

Display/audio drivers 310 can be any suitable circuitry for controlling and driving output to one or more display/audio output devices 312 in some embodiments. For example, display/audio drivers 310 can be circuitry for driving a touchscreen, a flat-panel display, a cathode ray tube display, a projector, a speaker or speakers, and/or any other suitable display and/or presentation devices.

Communication interface(s) 314 can be any suitable circuitry for interfacing with one or more communication networks, such as network 204 as shown in FIG. 2. For example, interface(s) 314 can include network interface card circuitry, wireless communication circuitry, and/or any other suitable type of communication network circuitry.

Antenna 316 can be any suitable one or more antennas for wirelessly communicating with a communication network (e.g., communication network 204) in some embodiments. In some embodiments, antenna 316 can be omitted.

Bus 318 can be any suitable mechanism for communicating between two or more components 302, 304, 306, 310, and 314 in some embodiments.

Any other suitable components can be included in hardware 300 in accordance with some embodiments.

Turning to FIG. 4, an example 400 of a process for generating and transmitting instructions for presenting a two-dimensional video content item in connection with spherical video content is shown in accordance with some embodiments of the disclosed subject matter. In some embodiments, blocks of process 400 can be implemented on server(s) 202.

Process 400 can begin by receiving an indication of a video content item that is to be presented on a user device at 402. In some embodiments, the indication can be received from the user device. For example, in some embodiments, process 400 can receive an indication of a video content item that was selected for presentation by a user of the user device. In some embodiments, the video content item can be any suitable type of video content, such as a single video, a video from a playlist of videos, a television program, a movie, live-streamed video content, and/or any other suitable type of video content.

In some embodiments, in response to receiving an indication of a video content item that is to be presented, process 400 can determine the capabilities of the user device. For example, process 400 can determine that the user device has device capabilities suitable for receiving and/or rendering spherical video content.

Process 400 can identify spherical video content that is related to the video content item at 404. For example, as described above in connection with FIGS. 1A and 1B, in some embodiments, the spherical video content can be related to a location of the video content item. As a more particular example, in some embodiments, the spherical video content can be content that depicts a location related to the video content item. As a specific example, in some embodiments, the location can be a photo and/or video of a landscape (e.g., a beach, a forest, and/or any other suitable type of landscape imagery), a photo and/or a video representing a particular geographic location (e.g., an iconic skyline of a particular city, photos and/or videos of famous attractions in a particular city or country, and/or any other suitable content), and/or a photo and/or a video related to a topic of the video content item (e.g., a photo of an old house if the video content item is a horror video, a photo or video of a space station if the video content item is related to space exploration, and/or any other suitable type of content). As another example, in some embodiments, the spherical video content can be an image and/or a video captured of a surrounding film set in which the video was filmed.

In some embodiments, the spherical video content can include interactive content. For example, if the video content item relates to space exploration, the spherical video content can include multiple background images of a space station, a video of outer space that depicts the viewer looking out of a window of the space station, and interactive elements associated with the space station (e.g., buttons corresponding to space station controls, latches for opening doors on the space station, etc.).

Note that, in some embodiments, the spherical video content can be content that has been recorded using any suitable number (e.g., one, two, five, ten, and/or any other suitable number) of cameras and covering any suitable field of view. For example, in some embodiments, multiplexed views in various directions can be recorded at the same time by one or more video capture devices, and the resulting video content can be stitched together to form the spherical video content. A viewer of the spherical video content can then use various user inputs (e.g., mouse clicks, selection on a touch screen, manipulation of the user device, eye gaze changes, and/or any other suitable user inputs) to change a viewpoint of the spherical video content and/or video content that is presented superimposed on the spherical video content, as described below.

Process 400 can identify the spherical video content using any suitable technique or combination of techniques. For example, in some embodiments, the spherical video content can be specified by a creator of the video content item, and process 400 can identify the spherical video content indicated by the creator.

As another example, in some embodiments, process 400 can identify the spherical video content based on metadata indicating a topic of the video content item and/or metadata indicating a topic and/or location associated with candidate spherical video content items. As a more particular example, in some embodiments, the metadata associated with the video content item can indicate location information (e.g., a geographic area, a type of landscape associated with a location, a type of building in which the video content item takes place, and/or any other suitable location information), timing information (e.g., a time of day in which the video content item takes place, a time of year and/or season in which the video content item takes place), and/or any other suitable type of information. In some such embodiments, process 400 can then identify a spherical video content item corresponding to the metadata, for example, by identifying spherical video content items depicting the location in which the video content item takes place, a season or time of year during which the video content item takes place, a type of building in which the video content item takes place, a landscape associated with a location in which the video content item takes place, and/or in any other suitable manner. In some embodiments, process 400 can use any suitable technique or combination of techniques to identify suitable background content items based on metadata, such as filtering candidate content items based on keywords, and/or any other suitable techniques.

As yet another example, in some embodiments, process 400 can identify the spherical video content based on image recognition. As a more particular example, in some embodiments, process 400 can identify one or more locations (e.g., a city or other geographic location, a type of building, a type of landscape, and/or any other suitable location information) associated with the video content item using any suitable image recognition techniques, and can identify spherical video content based on the identified location information (e.g., by selecting spherical video content that depicts the identified location, and/or in any other suitable manner).

Note that, in instances where process 400 identifies a spherical video content item, process 400 can present a suggestion to a creator of the video content item indicating that the spherical video content item has been identified as related to the video content item and allowing the creator of the video content item to link the video content item to the identified spherical video content item for future presentations of the video content item. Additionally, in some embodiments, process 400 can suggest associating the video content item with a spherical video content item to a creator of the video content item, for example, at a time when the creator of the video content item uploads the video content item to a server hosting the video content item. In some such embodiments, process 400 can then request that the creator of the video content item indicate a spherical video content item (e.g., by uploading a spherical video content item, by searching for and/or otherwise identifying the spherical video content item, and/or in any other suitable manner) to be associated with the video content item. Additionally or alternatively, in some embodiments, process 400 can automatically identify one or more candidate spherical video content items in response to receiving an indication from the creator of the video content item that the creator of the video content item would like to associate the video content item with a spherical video content item.

Additionally, note that, in some embodiments, the spherical video content can be computer-generated images and/or video. For example, in some embodiments, the spherical video content can be computer-generated imagery (CGI) depicting a landscape or other location at which the video content item takes place, a particular type of building at which the video content item takes place, and/or any other suitable imagery. In some such embodiments, the spherical video content can be generated by any suitable entity or device. For example, in some embodiments, the spherical video content can be generated by a server hosting the video content item, for example, in response to a request from a creator of the video content item to generate computer-generated imagery to be used as spherical video content when presenting the video content item. As a more particular example, in instances where the spherical video content is generated by the server hosting the video content item, the spherical video content can be generated based on any suitable information, such as metadata or keywords associated with the video content item that indicate a location of the video content item (e.g., a geographic location, a type of building, and/or any other suitable location), a genre or topic of the video content item (e.g., a horror film, a documentary about a particular topic, and/or any other suitable genre or topic), and/or any other suitable information. Additionally, in some embodiments, the spherical video content can be generated based on one or more image captures of still images from the video content item, for example, to detect a location or other information associated with the video content item prior to generation of the spherical video content. As another example, in some embodiments, the spherical video content can be generated by a device associated with a creator of the video content item, and can be uploaded to a server hosting the video content item to be presented in connection with the video content item.

In some embodiments, an identified spherical video content item (whether identified by a creator of the video content item, identified based on metadata, and/or identified in any other suitable manner) can be linked with the video content item in any suitable manner. For example, in some embodiments, an identifier of the spherical video content item can be stored in association with an identifier of the video content item, for example, in a database on server(s) 202.

Note that, in some embodiments, multiple spherical video content items can be identified. For example, in some embodiments, each of the multiple spherical video content items can correspond to a different segment of the video content item. As a more particular example, in some embodiments, a first spherical video content item can be identified that corresponds to a first location at which a first portion (e.g., a first duration of time, a first sequence of frames, and/or any other suitable portion) of the video content item takes place, and a second spherical video content item can be identified that corresponds to a different location at which a subsequent portion of the video content item takes place. As a specific example, in instances where a first portion of the video (e.g., from 1:00-5:00 of the video, and/or any other suitable portion) takes place in an outer space environment and a second portion of the video (e.g., from 5:01-7:00 of the video, and/or any other suitable portion) takes place in an environment on Earth, process 400 can cause the first spherical video content item to be a space ship presented during presentation of the first portion of the video and can cause the second spherical video content item to be a landscape located on Earth during presentation of the second portion of the video. In some embodiments, each of the multiple spherical video content items can be linked to the video content item, for example, in a database on server(s) 202. In some such embodiments, each identifier of the multiple spherical video content items can be associated with an indication of a portion of the video content item during which the spherical video content item is to be presented (e.g., during time 5:00 to 7:00 of the video content item, during frames 100-150 of the video content item, and/or in any other suitable manner). In some embodiments, a creator of the video can specify each of the multiple spherical video content items and/or the portions of the video during which each of the multiple spherical video content items is to be presented.

In some embodiments, when uploading the two-dimensional video content item to a server hosting content items, the content creator can be provided with an interface for selecting portions along a timeline of the two-dimensional video content item and assigning a particular spherical video content item to a particular portion of the timeline. In some embodiments, the content creator can be provided with an application program interface for indicating times or portions of a timeline and providing identifiers of spherical video content items that are associated with particular timing information of the two-dimensional video content item. Alternatively, in some embodiments, the content creator can indicate times or portions of a timeline that should have different spherical content items and, in response to providing such indications, a search for suitable spherical content items can be performed (e.g., analyzing the video frames, audio information, video characteristics information, audio characteristics information, subtitle information, etc. of the identified portion of the two-dimensional video content item and determining a matching spherical content item based on the analysis). In some embodiments, the matching spherical content item can be presented to the content creator for approval prior to association with the portion of the two-dimensional video content item.

Additionally, note that, in some embodiments, process 400 can synchronize times at which the spherical video content item and/or times at which particular spherical video content items are to be presented in connection with the video content item. For example, in some embodiments, process 400 can determine particular times at which no spherical video content item is to be presented. As a more particular example, in instances where the video content item is one that depicts multiple locations, process 400 can determine that a spherical video content item related to one of the multiple locations is to be presented during portions of the video content item that correspond to the particular location. As a specific example, if the video content item is a documentary about an animal that includes both outdoor landscape scenes and scenes of an indoor laboratory, process 400 can determine that a spherical video content item associated with the outdoor landscape scene is to be presented only during portions of the video content item depicting the outdoor landscape, and can inhibit presentation of the spherical video content item during other portions of the video content item. Additionally or alternatively, in some embodiments, process 400 can identify one or more other spherical video content items to be presented in connection with the other portions of the video content item.

At 406, process 400 can identify a position within the spherical video content item(s) at which the video content item is to be inserted (e.g., overlaid onto a window area for insertion of the video content item, superimposed over a particular portion of the spherical video content item, etc.). For example, in some embodiments, process 400 can identify coordinates of the spherical video content item(s) at which the video content item is to be centered. As another example, in some embodiments, process 400 can identify multiple coordinates that define a space within the spherical video content item(s) at which the video content can be presented. In some embodiments, process 400 can identify the position within the spherical video content item(s) at which the video content item is to be superimposed using any suitable technique(s). For example, in instances where the spherical video content item depicts multiple landscapes (e.g., in an instance where one view of the spherical video content item depicts a beach and a second view depicts a city in a different direction than the beach, and/or any other suitable views and landscapes), process 400 can identify the position based on an identification of a landscape or imagery that is related to the video content item. As a specific example, in instances where the video content item depicts a boat, a surfer, and/or any other type of images, process 400 can identify the position within the spherical video content item(s) as views that depict the ocean and/or a beach.

Additionally, in some embodiments, process 400 can determine a suitable zoom and/or enlargement factor of the spherical video content at which the video content item is to be superimposed. For example, in instances where the video content item depicts a boat, a surfer, and/or any other type of image with a particular size, process 400 can determine a zoom level to be applied to spherical video content depicting an ocean and/or beach such that the size of the images within the background video content item is suitable for superposition on the ocean and/or beach.

In some embodiments, process 400 can use any suitable image recognition techniques to identify the position within the spherical video content and/or any suitable resizing factors. For example, in some embodiments, process 400 can use image recognition to categorize different portions of the spherical video content as being associated with different landscapes based on objects recognized within the spherical video content, colors associated with the spherical video content, and/or any other suitable information.

At 408, process 400 can transmit, to the user device, instructions for presenting the video content in connection with the identified spherical video content. For example, in some embodiments, the instructions can cause the video content to be inserted into or superimposed on the spherical video content, as shown in and described above in connection with FIGS. 1A and 1B. As a more particular example, in some embodiments, the instructions can indicate one or more coordinates that specify a position within the spherical video content at which the video content is to be superimposed. As another more particular example, in some embodiments, the instruction can indicate a size of the video content, such as a height and/or width of a panel in which the video content is presented (e.g., in pixels, inches, and/or any other suitable metric).

In some embodiments, the instructions can indicate how presentation of the video content and/or the spherical video content is to be modified in response to receiving user inputs from the user device. For example, in some embodiments, the instructions can indicate that a viewpoint of the video content and the spherical video content is to be rotated, translated, scaled, panned, and/or modified in any other suitable manner in response to receiving inputs on the user device that click, pinch, and/or drag a user interface in which the content is being presented, as described below in connection with FIG. 5. As a more particular example, in some embodiments, the instructions can indicate that particular keystrokes, particular gestures, particular movements of the user device, and/or any other suitable user inputs are to cause a view of the spherical video content to change.

Note that, in some embodiments, the instructions can indicate multiple video content items that are to be inserted at different spatial positions within a spherical video content item. For example, in some embodiments, a first video content item can be inserted into the spherical video content item at a first position, and a second video content item can be inserted into the spherical video content item at a second position (e.g., 90 degrees to the right from the first position, 10 degrees above the first position, 10 degrees to the right and 10 degrees above the first position, and/or at any other suitable position). As a more particular example, in some embodiments, each of the video content items inserted into the spherical video content item can be created by the same entity. As a specific example, in an instance where the video content relate to advertisements for a particular product or type of products (e.g., a car, a computer, and/or any other suitable type of product), each of the video content items can be a video advertising the product at a different time (e.g., a model of a car from 2005 and a model of the car from 2015, and/or any other suitable times). Continuing with this example, a viewer of the spherical video content can navigate through the spherical video content to view the advertisements from different times, for example, by viewing the video corresponding to the oldest time first and then navigating (e.g., manipulating the spherical video to left, up, down, right, and/or in any other suitable direction) through the spherical video content to view one or more newer videos. In some embodiments, presentation of a particular video content item within the spherical video content can begin at time when the viewer manipulates the spherical video content to have a viewport that corresponds to the spatial position of the particular video content item. In some embodiments, any suitable number (e.g., one, two, five, ten, twenty, and/or any other suitable number) of video content items can be inserted in the spherical video content at any suitable positions. For example, in some embodiments, video content items can be inserted along a circumference of the spherical video content item at periodic spatial intervals (e.g., every 10 degrees, every 30 degrees, and/or any other suitable interval). In some embodiments, the instructions transmitted by process 400 can specify an identity of each of the video content items and a spatial position at which each video content item is to be inserted in the spherical video content.

In instances where multiple video content items are inserted within the spherical video content, process 400 can cause instructions to the viewer indicating a manner in which the spherical video content can be manipulated to view a particular video content item. For example, in some embodiments, while a viewer is viewing a first video content item at a first position, process 400 can concurrently present an instruction to manipulate the spherical video content to view a second video content item at a second position (e.g., “turn to the left,” “look behind you,” “look up,” and/or any other suitable instructions). In some embodiments, the instructions to manipulate the spherical content to view different video content items can be used to allow a viewer of the content to choose and/or shape a plot of the viewed content. For example, in some embodiments, the instructions can indicate that the viewer should manipulate the spherical content in a first direction to view a first video content item with a first plotline or that the viewer should manipulate the spherical content in a different, second direction to view a second video content item with a second plotline. In a more particular example in which multiple video content items are inserted within the spherical video content that relate to purchasing an automobile, the instructions to manipulate the spherical content to view different video content items can be used to allow a viewer of the content to select a video content item pertaining to a particular model of the automobile (e.g., “turn to the left to look at last year's model” or “turning back and forth between a left direction and a right direction allows you to see the changes from last year's model to this year's model”).

In some embodiments, the instructions can indicate times at which the spherical video content item and/or particular spherical video content items are to be presented in connection with the video content item. For example, in some embodiments, the instructions can indicate that the spherical video content item is to be presented during times 5:00 to 7:00 of the video content item and inhibited from presentation at other times. As another example, in some embodiments, the instructions can indicate that a first spherical video content item is to be presented during times 5:00 to 7:00 of the video content item and that a second spherical video content item is to be presented during times 7:01 to 9:00 of the video content item. Note that, in some embodiments, the instructions can indicate any suitable number of spherical video content items and/or any suitable combination of times for presentation or inhibition of the spherical video content items.

In some embodiments, the instructions can indicate that a brightness and/or saturation level of the spherical video content is to be adjusted to better match the video content item. Note that, in some embodiments, rather than transmitting instructions that cause the user device to modify the brightness or saturation level of the spherical video content, process 400 can adjust the appearance of the spherical video content and can store the modified spherical video content for future use in connection with the video content.

In some embodiments, process 400 can generate the instructions in any suitable manner. For example, in some embodiments, the instructions can be in any suitable format, such as a script or other suitable instructions that are transmitted from server(s) 202 to the user device. As a more particular example, the instructions can utilize WebGL, Unity, WebVR, and/or any other suitable tools and/or frameworks that can specify how the video content is to be rendered in connection with the spherical video content. In some embodiments, any tools that can be used to specify how two-dimensional video content is superimposed on three-dimensional spherical video content can be used to generate the instructions.

Note that, in some embodiments, process 400 can render a composite video that includes the video content item inserted into or superimposed on the spherical video content, and can transmit the composite video to the user device. For example, in some embodiments, process 400 can identify a position at which the video content item is to be positioned in relation to the spherical video content as described above, and can insert the video content item at the identified position to form the composite video. In some embodiments, the composite video can be encoded in any suitable format, for example, by projecting the spherical video content onto a two-dimensional plane and encoding the composite video as two-dimensional content. In some such embodiments, the instructions generated by process 400 and transmitted to the user device can include instructions for rendering the two-dimensional composite video as a two-dimensional video content item inserted into or superimposed on three-dimensional spherical video content.

Turning to FIG. 5, an example 500 of a process for presenting video content in connection with spherical video content on a user device is shown in accordance with some embodiments of the disclosed subject matter. In some embodiments, block of process 500 can be executed on user device 206.

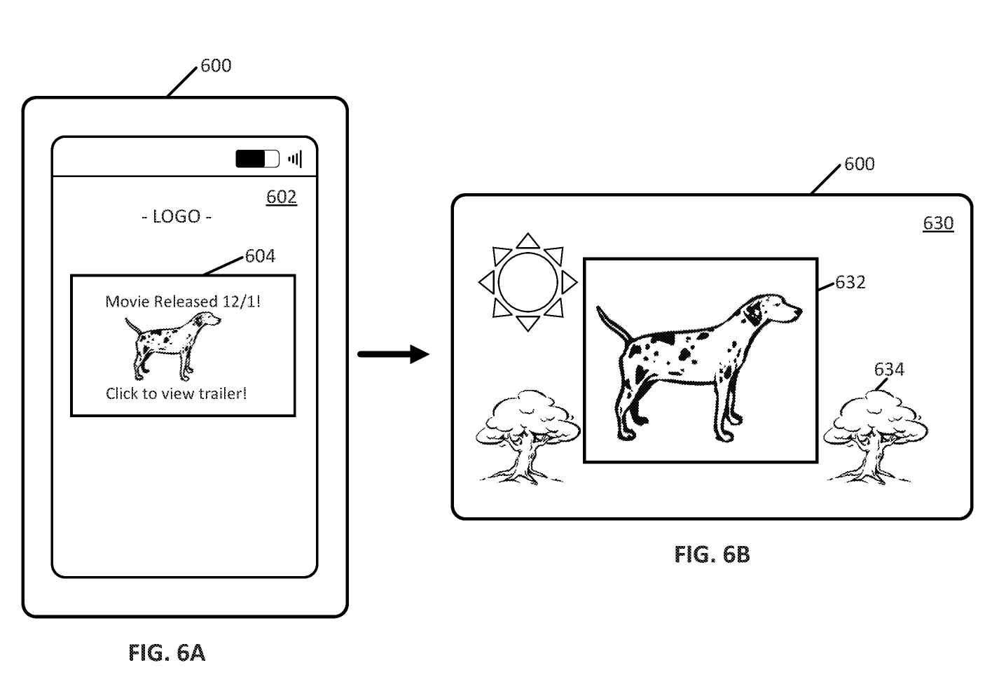

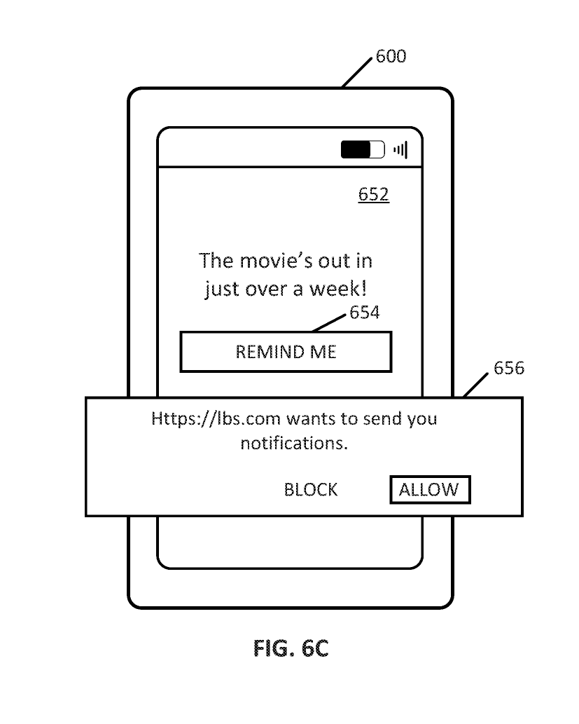

Process 500 can begin by transmitting an indication of a selected video content item at 502. For example, in some embodiments, the indication can be transmitted to server(s) 202, which can be a server that hosts media content (including the selected video content item) and transmits content to user devices in response to receiving a request. In some embodiments, the video content item can be selected in any suitable manner. For example, in some embodiments, a video content item can be selected from a list of available video content items presented in an application or browser window presented on the user device. As another example, in some embodiments, the video content item can be selected via selection of a hyperlink to the video content item. In some embodiments, the video content item can be selected from any suitable page. For example, in some embodiments, the video content item can be selected from a link on a web page displayed in a browser window. In a more particular example, the video content item can be selected from a link to an advertisement link that is presented on a web page. An example 602 of a user interface that can present a link to an advertisement presented on a web page is shown in FIG. 6A. As illustrated, user interface 602 can be presented on a user device, such as mobile device 600 (e.g., a mobile phone, a tablet computer, a laptop computer, and/or any other suitable type of user device). In some embodiments, the web page can include any suitable content, such as a logo, text, photos, images, videos, links, and/or any other suitable content, which can include advertisement link 604. In some embodiments, selection of advertisement link 604 can cause an indication of a video content item associated with advertisement link 604 (e.g., an identifier of the associated video advertisement, and/or any other suitable indication) to be transmitted to server(s) 202.

At 504, process 500 can receive instructions for presenting the video content item such that it is inserted into related spherical video content. In some embodiments, the instructions can be received in response to a request for the selected video content item. An example of instructions that can be received is described above in connection with block 408 of FIG. 4. In some embodiments, the instructions can include locations of the video content item and/or the spherical video content, such as Uniform Resource Locators (URLs).

At 506, process 500 can cause the video content to be presented in connection with the spherical video content on the user device using the received instructions. For example, as shown in and described above in connection with FIGS. 1A and 1B, process 500 can cause the video content to be superimposed on the spherical video content. In some embodiments, process 500 can utilize the instructions to render the content on the user device. For example, in some embodiments, process 500 can use the instructions to determine a position at which the video content is superimposed on the spherical video content, any suitable lighting effects for the video content and/or the spherical video content, a viewer perspective of the video content and/or the spherical video content, and/or any other suitable information. In some embodiments, process 500 can interpret the instructions through a browser that is being used to present the video content.

Note that, in some embodiments, process 500 can cause the video content to be presented in a full-screen mode, as shown in user interface 630 of FIG. 6B. For example, in instances where the video content was selected at block 502 from a link on a web page within a browser window (e.g., as shown in FIG. 6A), process 500 can cause video content 632 and the associated spherical video content 634 to be maximized and presented within a full-screen view on the user device, as shown in FIG. 6B. Note that, in some embodiments, process 500 can cause user interface 630 to be presented in a different orientation than user interface 602, as shown in FIGS. 6A and 6B. For example, in some embodiments, a full-screen mode can be presented in a landscape orientation, as shown in FIG. 6B. Alternatively, in some embodiments, process 500 can cause user interface 630 to be presented in the same orientation as the page from which the link was selected can cause the orientation to be rotated in response to a user input (e.g., rotation of user device 600, and/or any other suitable type of user input). In some embodiments, any suitable video player controls (e.g., a volume control, a pause button, a rewind control, and/or any other suitable controls) can be hidden during full-screen presentation of the video content. Alternatively, in some embodiments, the video content can be presented within a video player window of the browser window from which the link was selected.

At 508, process 500 can receive a user input indicating that a viewpoint of the presentation of the video content is to be changed. For example, the user input can be a mouse click, keyboard inputs, inputs from a touchscreen, changes in eye gaze, and/or any other suitable inputs. In some embodiments, the user input can indicate a direction in which the viewpoint of the video content and/or spherical video content is to be changed, as described above in connection with FIGS. 1A and 1B. As a more particular example, in some embodiments, the input can be received from a keyboard and/or a keypad associated with the user device. As a specific example, particular keys (e.g., arrow keys, particular characters, and/or any other suitable keys) can correspond to different changes in view, such as a panning in a particular direction (e.g., left, right, up, down, and/or in any other suitable direction). As another more particular example, in some embodiments, the input can be received from a touchscreen associated with the user device. As a specific example, swiping on the touchscreen can indicate that the view is to be changed to show a portion of the spherical video content corresponding to a direction indicated by the swipe. As yet another more particular example, in some embodiments, the input can be received from an accelerometer associated with the user device. As a specific example, the accelerometer can indicate that the user device has been moved in a particular direction and/or at a particular velocity, and can determine that the view is to be changed in a direction corresponding to the direction and velocity of the user device. As still another more particular example, in some embodiments, the input can be determined based on an eye tracker associated with the user device that measures a direction of shift in eye gaze. As a specific example, the input can indicate that a user of the user device has shifted their eye gaze in a particular direction, and can indicate that the view is to be changed to correspond to a location associated with the shifted eye gaze location.

At 510, process 500 can update presentation of the video content item and the spherical video content based on the received user input. In some embodiments, a change in the viewpoint can cause a different portion of the video content and/or the spherical video content to be shown. For example, in some embodiments, translating the video content and the spherical video content to the right can cause previously hidden portions of the spherical video content to be presented on the left and can cause some portion of the video content and/or the spherical video content on the right to be inhibited from presentation, as shown in and described above in connection with FIG. 1B. Note that, in some embodiments, process 500 can continue presenting the video content item while the viewpoint of the spherical video content is changed and after the viewpoint of the spherical video content is changed.

Process 500 can then loop back to 508 and continue presenting the video content in connection with the spherical video content until another user input is received. In some embodiments, process 500 can terminate when presentation of the video content item has finished and/or a user interface presenting the video content is dismissed or closed by a user of the user device.

Note that, in some embodiments, process 500 can present a notification or any other suitable information related to the video content item on the user device in response to determining that presentation of the video content item has finished. For example, in instances where the video content item relates to a movie or television program (e.g., a preview of a movie, a preview of a particular episode of a television program or of a particular television series, and/or any other suitable type of content), process 500 can cause a notification reminding a user of the user device to view the movie or television program. As another example, as shown in user interface 652 of FIG. 6C, in some embodiments, process 500 can present a notification asking permission to present a reminder to view the movie or television program at a later date (e.g., at a date or time just before release of the movie or television program, at a date or time just after release of the movie or television program, and/or any other suitable subsequent date or time). In some such embodiments, user interface 652 can include a message (e.g., indicating that the movie will be released at a particular date, and/or any other suitable information) and a selectable input 654 that allows a user of user device 600 to opt to receive reminder notifications. In some embodiments, selection of selectable input 654 can cause message 656 to be presented, which can allow a user of user device 600 to confirm that the user wants to receive one or more notifications or reminders in the future. In some embodiments, message 656 can additionally include a selectable input to disable notifications or reminders, as shown in FIG. 6C.

In some embodiments, at least some of the above described blocks of the processes of FIGS. 4 and 5 can be executed or performed in any order or sequence not limited to the order and sequence shown in and described in connection with the figures. Also, some of the above blocks of FIGS. 4 and 5 can be executed or performed substantially simultaneously where appropriate or in parallel to reduce latency and processing times. Additionally or alternatively, some of the above described blocks of the processes of FIGS. 4 and 5 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personal information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for enhancing two-dimensional video content items with spherical video content are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A method for enhancing video content items, the method comprising:
receiving an indication of a two-dimensional video content item to be presented on a user device;
determining image information associated with one or more image frames of the two-dimensional video content item;
identifying spherical video content based on the image information associated with the one or more image frames of the two-dimensional video content item, wherein the spherical video content is identified based on the determined image information and based on a topic of the two-dimensional video content item, and wherein the spherical video content includes a plurality of views;
identifying a position corresponding to a first view of the plurality of views within the related spherical video content at which to insert the two-dimensional video content item; and
generating a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

2. The method of claim 1, wherein the related spherical video content is related to an environment depicted in the one or more image frames of the two-dimensional video content item.

3. The method of claim 1, wherein inserting the two-dimensional video content item within the related spherical video content at the identified position corresponding to the first view for presentation on the user device further comprises transmitting instructions to the user device that include one or more coordinates at which the two-dimensional video item is to be positioned relative to the spherical video content.

4. The method of claim 1, wherein identifying the spherical video content comprises determining an identifier corresponding to the spherical video content that is stored in association with an identifier of the two-dimensional video content item.

5. The method of claim 1, wherein an identity of the spherical video content item is specified by a content creator of the two-dimensional video content item.

6. The method of claim 1, wherein identifying the spherical video content comprises:
identifying a plurality of candidate spherical video content based on first metadata associated with the two-dimensional video content item and second metadata associated with the two-dimensional video content item; and
selecting at least one candidate spherical video content item from the plurality of candidate spherical video content.

7. The method of claim 1, further comprising causing the two-dimensional video content item to be inserted within second spherical video content during presentation of a second portion of the two-dimensional video content item, wherein the second spherical video content is related to the one or more image frames associated with the second portion of the two-dimensional video content item and wherein the two-dimensional video content item is inserted within the related spherical video content during presentation of a first portion of the two-dimensional video content item.

8. The method of claim 1, further comprising modifying at least one visual characteristic of the related spherical video content based on visual characteristics of the two-dimensional video content item.

9. The method of claim 1, further comprising:
identifying one or more portions of the two-dimensional video content item that are unrelated to the spherical video content; and
inhibiting presentation of the spherical video content during presentations of the one or more portions of the two-dimensional video content item that are unrelated to the spherical video content.

10. The method of claim 1, wherein presentation of the spherical video content item is performed in a full-screen mode.

11. The method of claim 1, further comprising causing a notification related to the two-dimensional video content item to be presented on the user device in response to determining that presentation of the spherical video content item on the user device has been completed.

12. A system for enhancing video content items, the system comprising:
a hardware processor that is configured to:
receive an indication of a two-dimensional video content item to be presented on a user device;
determine image information associated with one or more image frames of the two-dimensional video content item;
identify spherical video content based on the image information associated with the one or more image frames of the two-dimensional video content item, wherein the spherical video content is identified based on the determined image information and based on a topic of the two-dimensional video content item, and wherein the spherical video content includes a plurality of views;
identify a position corresponding to a first view of the plurality of views within the related spherical video content at which to insert the two-dimensional video content item; and
generate a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.

13. The system of claim 12, wherein the related spherical video content is related to an environment depicted in the one or more image frames of the two-dimensional video content item.

14. The system of claim 12, wherein inserting the two-dimensional video content item within the related spherical video content at the identified position corresponding to the first view for presentation on the user device further comprises transmitting instructions to the user device that include one or more coordinates at which the two-dimensional video item is to be positioned relative to the spherical video content.

15. The system of claim 12, wherein the hardware processor is further configured to determine an identifier corresponding to the spherical video content that is stored in association with an identifier of the two-dimensional video content item.

16. The system of claim 12, wherein an identity of the spherical video content item is specified by a content creator of the two-dimensional video content item.

17. The system of claim 12, wherein the hardware processor is further configured to:
identify a plurality of candidate spherical video content based on first metadata associated with the two-dimensional video content item and second metadata associated with the two-dimensional video content item; and
select at least one candidate spherical video content item from the plurality of candidate spherical video content.

18. The system of claim 12, wherein the hardware processor is further configured to cause the two-dimensional video content item to be inserted within second spherical video content during presentation of a second portion of the two-dimensional video content item, wherein the second spherical video content is related to the one or more image frames associated with the second portion of the two-dimensional video content item and wherein the two-dimensional video content item is inserted within the related spherical video content during presentation of a first portion of the two-dimensional video content item.

19. The system of claim 12, wherein the hardware processor is further configured to modify at least one visual characteristic of the related spherical video content based on visual characteristics of the two-dimensional video content item.

20. The system of claim 12, wherein the hardware processor is further configured to:
identify one or more portions of the two-dimensional video content item that are unrelated to the spherical video content; and
inhibit presentation of the spherical video content during presentations of the one or more portions of the two-dimensional video content item that are unrelated to the spherical video content.

21. The system of claim 12, wherein presentation of the spherical video content item is performed in a full-screen mode.

22. The system of claim 12, wherein the hardware processor is further configured to cause a notification related to the two-dimensional video content item to be presented on the user device in response to determining that presentation of the spherical video content item on the user device has been completed.

23. A non-transitory computer-readable medium containing computer-executable instructions that, when executed by a processor, cause the processor to perform a method for enhancing two-dimensional video content items is provided, the method comprising:
receiving an indication of a two-dimensional video content item to be presented on a user device;
determining image information associated with one or more image frames of the two-dimensional video content item;
identifying spherical video content based on the image information associated with the one or more image frames of the two-dimensional video content item, wherein the spherical video content is identified based on the determined image information and based on a topic of the two-dimensional video content item, and wherein the spherical video content includes a plurality of views;
identifying a position corresponding to a first view of the plurality of views within the related spherical video content at which to insert the two-dimensional video content item; and
generating a spherical video content item by inserting the two-dimensional video content item within the related spherical video content at the identified position corresponding to the first view for presentation on the user device, wherein, in response to receiving a user input from the user device to change a viewpoint of the spherical video content item, the related spherical video content within the spherical video content item is modified to a second view of the plurality of views while the two-dimensional content item within the spherical video content item is continued to be presented at the identified position.
